(19) United States
(12) Patent Application Publication
(10) Pub. No.: US 2008/0021831 A1
(43) Pub. Date: Jan. 24, 2008

(54) Methods of processing a check in a payee positive pay system

(76) Inventors: Andrew Blaikie, Waterloo (CA); Stephen Ebert, Plymouth, MN (US)

Correspondence Address: MICHAEL CHAN;NCR CORPORATION, 1700 SOUTH PATTERSON BLVD, DAYTON, OH, 45479-0001, US

(21) Appl. No.: 11/489,288

(22) Filed: Jul. 19, 2006

(51) Int. Cl. G06Q 40/00

(52) U.S. Cl. 705/45

(57) ABSTRACT

A method is provided of processing a check in a payee positive pay system. The method comprises receiving a check from a presenting bank, obtaining an amount of the check received from the presenting bank, recognizing a payee name from the check received from the presenting bank, selecting one of a plurality of recognition confidence thresholds based upon the amount of the check, and based upon the selected one of the recognition thresholds, comparing the recognized payee name with a payee name contained in a check data file which has been previously received from a payor of the check to determine if there is a match of payee names.

### BACKGROUND

The present invention relates to processing checks in a payee positive pay system, and is particularly directed to methods of processing a check in a payee positive pay system.

Check fraud is a problem which is costing banks significant amounts of money. One type of check fraud includes counterfeiting a check. Another type of check fraud includes forging a payor signature on a legitimate blank check. Still another type of check fraud includes altering a legitimate check, such as altering the amount of the check or altering the payee of the check.

There are a number of known products available in the marketplace to detect fraudulent checks. One such product is a “positive pay” system in which a payor of a check provides his/her bank (i.e., the paying bank) with details of issued checks. These details are contained in a positive pay file which is electronically sent from the check payor to the paying bank. When a presenting bank presents one of the issued checks to the paying bank, the paying bank captures check data from the presented check and compares the captured check data to check details retrieved from the positive pay file to verify that the presented check has not been altered. The comparison is based primarily on the amount of the check and the serial number of the check to enable the paying bank to catch altered check amounts and duplicate checks.

A known enhancement to positive pay systems also captures the payee name to verify that the presented check has not been altered. These enhanced positive pay systems are known as “payee positive pay” systems. In a typical payee positive pay system, a recognition engine is used to perform ink character recognition on a check to ensure that the payee name appearing on the check matches the payee name which the check payor originally put on the check. When the recognition engine is unable to ensure that the payee names match, the check is rejected and presented to a human operator for manual review.

From time to time, a check has a correct payee name thereon, but is flagged as being a mismatch with the payee name that the check payor originally put on the check. This occurrence is known as a “false positive”. As an example, the rate of false positives may be ten percent. The total number of checks being processed by the recognition engine is usually relatively large. For example, over a 100,000 checks could be processed by the recognition engine in a single day. If 100,000 checks are processed and the rate of false positives is ten percent, then there would be approximately 10,000 checks for the human operator to manually review. Since the number of false positives presented to the human operator for manual review would be relatively large, an unfavorable business case may arise where the cost to review exceeds the cost of the fraud losses avoided. Or equally problematic, the manual review process may be unsuccessful because of the “needle in the haystack” syndrome in which the human operator may not be alert enough to identify and sort out the relatively few checks from a group of thousands of checks presented for manual review. It would be desirable to reduce the number of false positives presented to the human operator for manual review so that the human operator can focus on fewer checks and, therefore, perform the job more quickly and with greater accuracy.

### SUMMARY

In accordance with an embodiment of the present invention, a method is provided of processing a check in a payee positive pay system. The method comprises receiving a check from a presenting bank, obtaining an amount of the check received from the presenting bank, recognizing a payee name from the check received from the presenting bank, selecting one of a plurality of recognition confidence thresholds based upon the amount of the check, and based upon the selected one of the recognition thresholds, comparing the recognized payee name with a payee name contained in a check data file which has been previously received from a payor of the check to determine if there is a match of payee names.

### BRIEF DESCRIPTION OF THE DRAWINGS

In the accompanying drawings:

FIG. 1 is a schematic diagram representation of an example known payee positive pay system;

FIG. 2 is a flow diagram which depicts steps of a known process used in the system of FIG. 1;

FIG. 3 is a flow diagram which depicts steps of a known sub-process in the known process of FIG. 2;

FIGS. 4A and 4B are tables which illustrate a known relationship between a confidence threshold and the number of false positives associated with this confidence threshold used in the known sub-process of FIG. 3;

FIGS. 5A and 5B are tables similar to the tables of FIGS. 4A and 4B, and which illustrate another known relationship between a different confidence threshold and the number of false positives associated with this confidence threshold;

FIG. 6 is a flow diagram, similar to FIG. 3, which depicts steps of a sub-process in accordance with an embodiment of the present invention; and

FIGS. 7A and 7B are tables which illustrate a relationship, in accordance with an embodiment of the present invention, between tiered recognition confidence thresholds and the number of false positives associated with these tiered recognition confidence thresholds used in the sub-process of FIG. 6.

### DETAILED DESCRIPTION

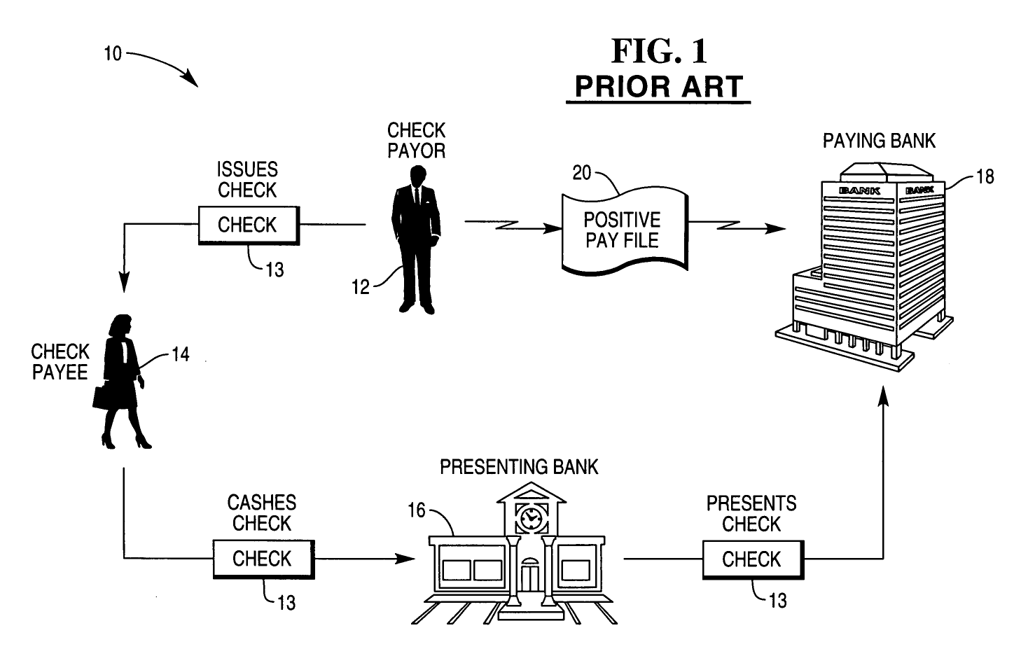

A known payee positive pay system 10 is illustrated in FIG. 1. As shown in FIG. 1, a check payor 12 issues a check 13 to a check payee 14 who, in turn, cashes the check at a presenting bank 16. The presenting bank 16 then presents the check 13 to a paying bank 18 in conventional manner.

When the check payor 12 issues the check 13 to the check payee 14, as just described hereinabove, the check payor electronically transmits a positive pay file 20 to the paying bank 18. The positive pay file 20 and the process of electronically sending the positive pay file to the paying bank 18 are conventional and, therefore, will not be described in detail. Briefly, the positive pay file 20 includes details of checks which have been issued by the check payor 12. The check details include check amount and payee name. Thus, the positive pay file 20 includes details of the particular check 13 which the check payor 12 issued to the check payee 14.

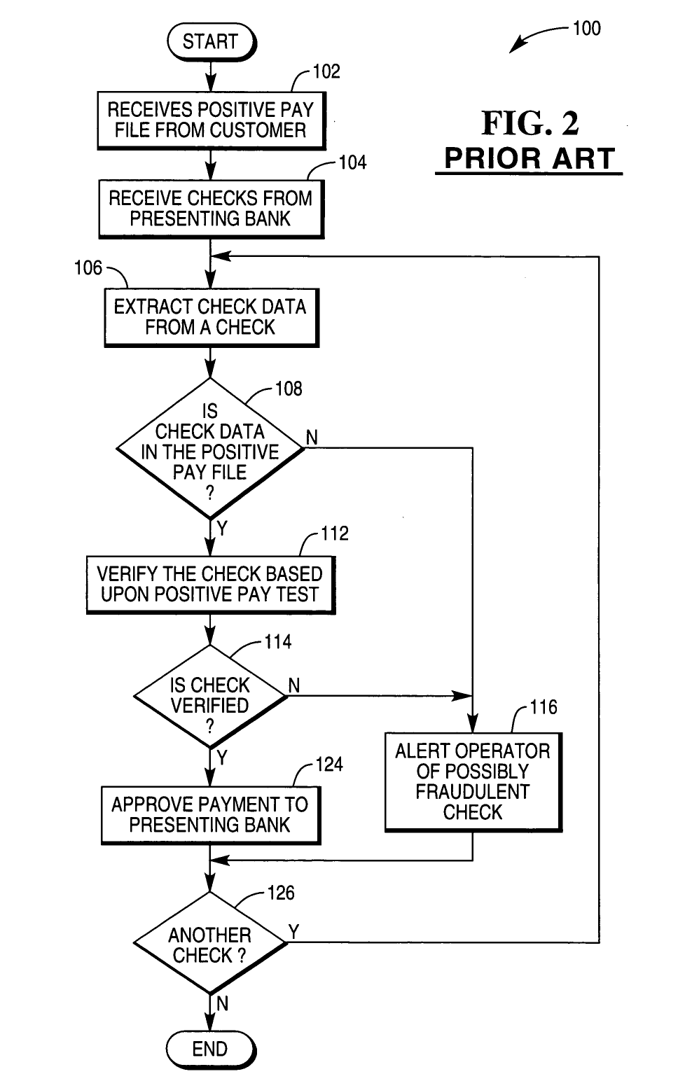

Referring to FIG. 2, a flow diagram 100 depicts steps of a known payee positive pay process. In step 102, the paying bank 18 receives the positive pay file 20 from the check payor 12. Further, the paying bank 18 receives checks from the presenting bank 16 requesting payment for the checks, as shown in step 104. In step 106, check data, such as check account number and check serial number, is extracted from a check (e.g., the check 13).

A determination is made in step 108 as to whether or not the check 13 has corresponding check data contained in the positive pay file 20 which has been received from the check payor 12. If there is no corresponding check data contained in the positive pay file 20, the process proceeds to step 116 to alert a human operator (such as a person at the paying bank 18) of a potentially fraudulent check. The process then proceeds to step 126 in which a determination is made as to whether another check is available to be processed. If the determination in step 126 is affirmative, the process returns to step 106 to process the next check. Otherwise, the process ends.

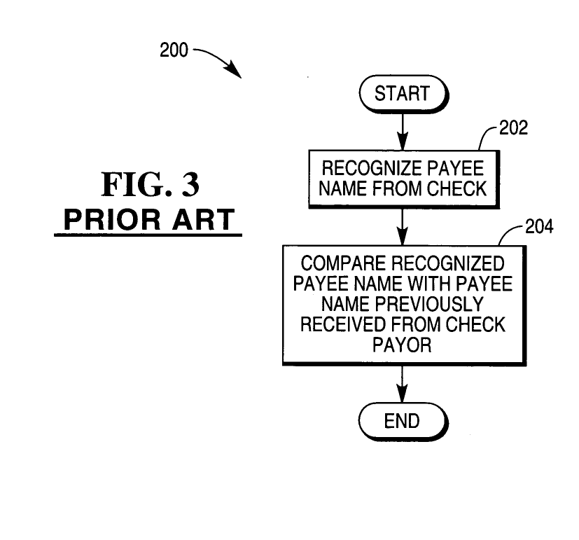

If there is corresponding check data contained in the positive pay file 20 as determined in step 108, the process proceeds to step 112 to verify that the check 13 has not been altered. The verification occurring in step 112 is based upon a number of conventional positive pay tests, as is known. These conventional tests in a payee positive pay process would include a known sub-process 200 (such as shown in FIG. 3) of payee name recognition and comparison of the recognized payee name with a payee name previously received from the check payor 12. The known sub-process 200 shown in FIG. 3 comprises step 202 in which a recognition engine performs recognition on the payee name from the check 13. Then, in step 204, the recognized payee name from step 202 is compared with a payee name previously received in the positive pay file 20 from the check payor 12. The sub-process 200 shown in FIG. 3 is conventional in known payee positive pay systems and, therefore, will not be described in detail.

A determination is then made in step 114 as to whether or not the check 13 has been verified in step 112. If the determination in step 114 is negative, the process proceeds to step 116 to alert a human operator of a possible fraudulent check. However, if the determination in step 114 is affirmative, the process proceeds to step 124 in which approval is provided to make payment in the amount of the check 13 to the presenting bank 16. The process then proceeds to step 126 in which a determination is made as to whether another check is available to be processed. If the determination in step 126 is affirmative, the process returns to step 106 to process the next check. Otherwise, the process ends.

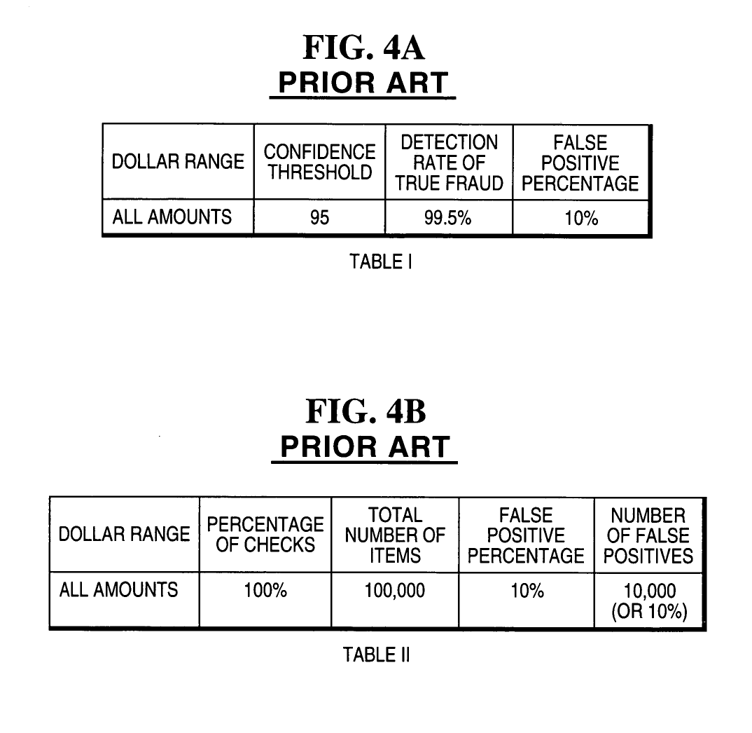

Referring to FIGS. 4A and 4B, a Table I and a Table II are illustrative of a known relationship between a confidence threshold and the number of false positive items associated with the confidence threshold when the known sub-process 200 shown in FIG. 3 is carried out. It should be noted that a check item is considered to be a mismatch when the recognition confidence is determined to be below the confidence threshold. As shown in Table I in FIG. 4A, when a confidence threshold of ninety-five (95) is used, there is a ninety-nine and one-half (99.5) percent detection rate of true fraud and a ten (10) percent rate of false positives. Given a total number of 100,000 check items and a ten percent rate of false positives for all check amounts, there would be a total number of 10,000 false positives (i.e., 10% of 100,000 items), as shown in Table II in FIG. 4B.

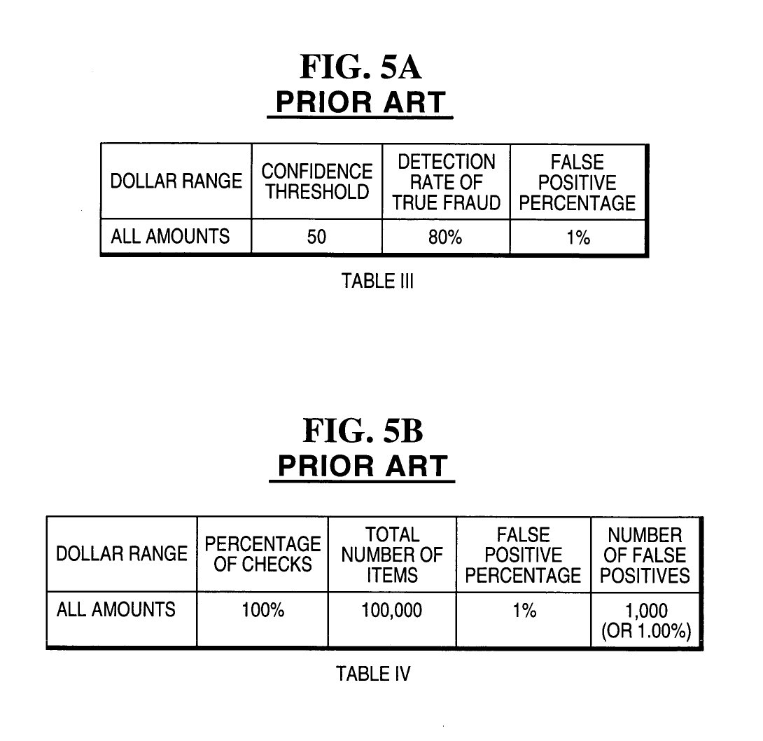

Referring to FIGS. 5A and 5B, a Table III and a Table IV are illustrative of a known relationship between a different confidence threshold and the number of false positive items associated with this confidence threshold when the known sub-process 200 shown in FIG. 3 is carried out. Again, it should be noted that a check item is considered to be a mismatch when the recognition confidence for the particular check item is determined to be below the confidence threshold. As shown in Table III in FIG. 5A, when a confidence threshold of fifty (50) is used, there is an eighty (80) percent detection rate of true fraud and a one (1) percent rate of false positives. Given again a total of 100,000 check items and now this time a one percent rate of false positives for all check amounts, there would be a total number of 1000 false positives (i.e., 1% of 100,000 items), as shown in Table IV in FIG. 5B.

It should be apparent that in the known relationships depicted in FIGS. 4A, 4B, 5A, and 5B, the total number of false positives for all check amounts decreases as the confidence threshold is set lower. However, there is a drawback to setting a lower confidence threshold because some check items will be missed as a true positive. While it may be acceptable to miss some lower amount checks which are true positives, it would not be acceptable to miss some higher amount checks which are true positives because this would result in too great of a financial loss.

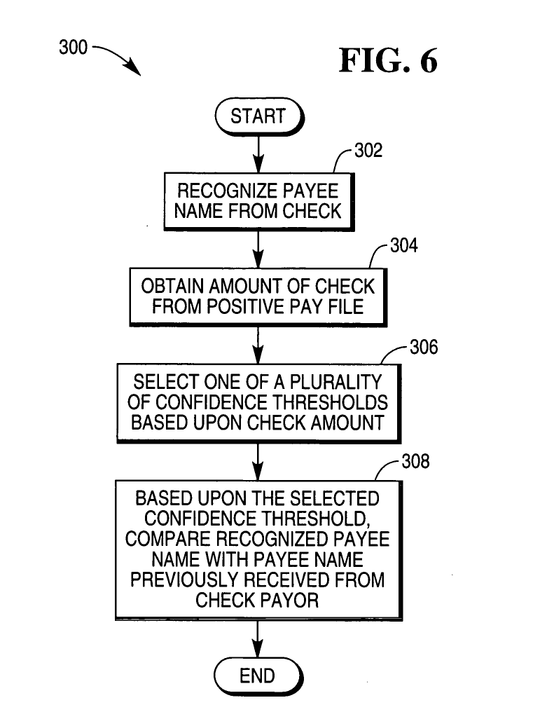

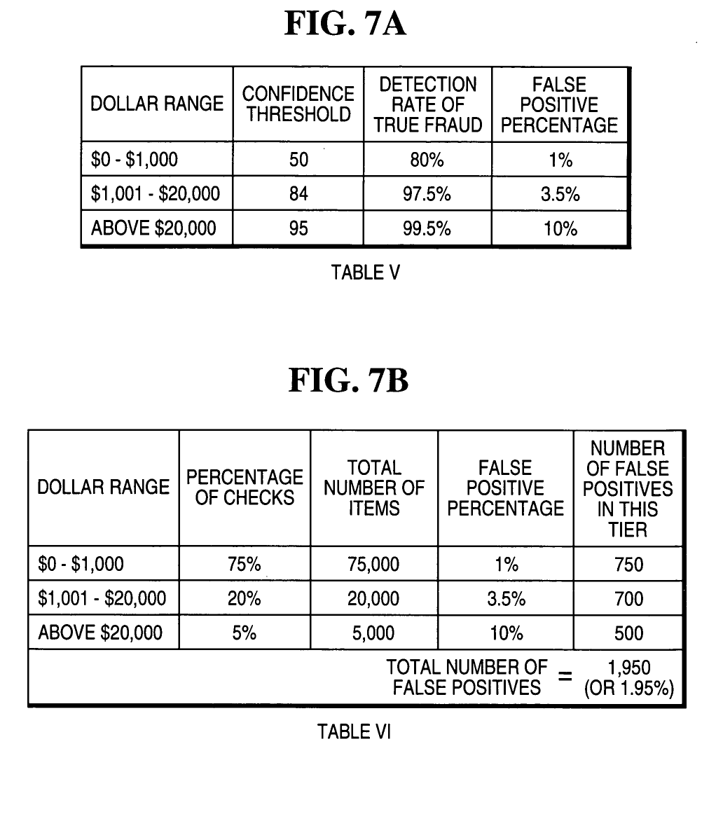

Referring to FIG. 6, a sub-process 300 in accordance with an embodiment of the present invention is illustrated. The sub-process 300 illustrated in FIG. 3 is used in place of the known sub-process 200 shown in FIG. 3. More specifically, in step 302, recognition is performed on the payee name from the check 13. The amount of the check 13 is obtained from the positive pay file 20, as shown in step 304. In step 306, one of a plurality of recognition confidence thresholds is selected based upon the check amount obtained in step 304. These plurality of confidence thresholds are tiered as will be better explained hereinbelow with reference to FIGS. 7A and 7B. Then, in step 308, based upon the selected one of the recognition confidence thresholds in step 306, the recognized payee name from step 302 is compared with a payee name previously received in the positive pay file 20 from the check payor 12.

Referring to FIGS. 7A and 7B, a Table V and a Table VI are illustrative of a relationship, in accordance with an embodiment of the present invention, between the plurality of recognition confidence thresholds and the number of false positives associated with these plurality of confidence thresholds. As shown in Table V in FIG. 7A, when the amount of the check item is up to $1000, a first confidence threshold of fifty (50) is used. When the first confidence threshold of fifty is used, there is an eighty (80) percent detection rate of true fraud and a one (1) percent rate of false positives. Also, as shown in Table V in FIG. 7A, when the amount of the check item is between $1001 and $20,000, a second confidence threshold of eighty-four (84) is used. When the second confidence threshold of eighty-four is used, there is a ninety-seven and one-half (97.5) percent detection rate of true fraud and a three and one half (3.5) percent rate of false positives. Further, as shown in Table VI in FIG. 7A, when the amount of the check item is over $20,000, a third confidence threshold of ninety-five (95) is used. When the third confidence threshold of ninety-five is used, there is a ninety-nine and one half (99.5) percent detection rate of true fraud and a ten (10) percent rate of false positives.

Assuming that only about seventy-five (75) percent of all the check items being processed has an amount up to $1000 and given a false positive percentage of one percent for these checks, there would be a total of 750 false positives, as shown in Table VI in FIG. 7B. Similarly, assuming that only about twenty (20) percent of all the check items being processed has an amount between $1001 and $20,000 and given a false positive percentage of 3.5 percent for these checks, there would be a total of 700 false positives, as shown in Table VI in FIG. 7B. Again, similarly, assuming that the remaining five (5) percent of all checks has an amount over $20,000 and given a false positive percentage of ten percent for these checks, there would be a total of 500 false positives, as shown in Table VI in FIG. 7B. Accordingly, the total number of all false positives using the tiered confidence thresholds of FIGS. 7A is 1950 (i.e., 750+700+500) as shown in FIG. 7B.

It should be apparent that the use of a plurality of different recognition confidence thresholds (i.e., the tiered confidence thresholds shown in Table V in FIG. 7A) results in a relatively higher percentage (10% in this example) of false positives for those check items which have amounts over $20,000, and a relatively lower percentage (1% in this example) of false positives for those check items which have amounts up to $1000. The percentage of false positives for those check items which have amounts between $1001 and $20,000 is 3.5% which is between the 10% (for check amounts over $20,000 ) and the 1% (for check amounts up to $1000).

It should be noted that the total number of false positives in Table VI in FIG. 7B for check amounts over $20,000 and presented for manual review is 500. This 500 number in Table VI in FIG. 7B is the same as the total number of false positives in Table II in FIG. 4B for check amounts over $20,000 (i.e., 5% of all checks (100,000) is equal to 5000 checks, and a 10% false positives rate makes the total number of false positives equal to 500). While the total number of false positives in Table VI in FIG. 7B would be the same as the total number of false positives in Table II in FIG. 4B for amounts over $20,000 , it should be noted that the total number of false positives in Table VI in FIG. 7B for all check amounts (i.e., 1950) is significantly less than the total number of false positives in Table II in FIG. 4B for all check amounts (i.e., 10,000). The reduction from 10,000 to 1850 false positives for all check amounts is a significant reduction of the total number of checks which need to be reviewed by the human operator. Since the human operator has significantly fewer checks to review, the operator can better focus on the relatively fewer checks. With better focus, the operator can perform the job of reviewing the checks more quickly and with greater accuracy.

Moreover, it should be noted that even though the total number of checks which need to be reviewed by the human operator has been reduced, the total number checks in the relatively higher amounts (i.e., over $20,000 ) in Table VI in FIG. 7B is substantially the same as the total number of checks over $20,000 in Table II in FIG. 4B. In this regard, note from FIG. 4B that the total number of checks over $20,000 is 5000 (i.e., 5% of 100,000), and that the number of false positives for these 5000 checks is 500 (i.e., 10% of 5000). This number of 500 false positives associated with FIG. 4B is the same as the number of 500 false positives associated with FIG. 7B. Accordingly, by using a plurality of different recognition confidence thresholds as illustrated in FIGS. 6, 7A, and 7B, the result is a significant reduction of total number of false positives for all check amounts (as evidenced by the reduced number of false positives from 10,000 to 1950 for all check amounts as just described hereinabove) with essentially no reduction of the total number of false positives in the higher amount checks (as evidenced by the unchanged number of 500 false positives for check amounts over $20,000 also as just described hereinabove).

Although the above description of FIG. 7A describes three different dollar ranges with different confidence thresholds, it is conceivable that less than three (i.e., only two) or more than three different dollar ranges with different confidence thresholds be used. It should also be noted that all of the numbers used in the tables of FIGS. 7A and 7B are just examples to show relationships. Accordingly, the specific dollar ranges illustrated in FIG. 7A are only examples, and the specific confidence thresholds illustrated in FIG. 7A are also only examples.

Further, although the above description describes the presenting bank 16 presenting a physical check to the paying bank 18, it is conceivable that the presenting bank may present an image of the check, instead of the physical check, to the paying bank. The presenting bank 16 would electronically transmit the image of the check to the paying bank 18.

Also, although the above description describes the check payor 12 electronically transmitting the positive pay file 20 to the paying bank 18, it is conceivable that a check data file which is other than a positive pay file be electronically transmitted instead of the positive pay file. It is conceivable that the check data file includes check information such as the check account number and check serial numbers of completed checks which have been issued by the check payor 12. It is also conceivable that the check payor 12 may log onto a website to type in the check information on a web-based form on a screen, or may access a custom application and enter in the check information.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of processing a check in a payee positive pay system, the method comprising:
receiving a check from a presenting bank;
obtaining an amount of the check received from the presenting bank;
recognizing a payee name from the check received from the presenting bank;
selecting one of a plurality of recognition confidence thresholds based upon the amount of the check; and
based upon the selected one of the recognition thresholds, comparing the recognized payee name with a payee name contained in a check data file which has been previously received from a payor of the check to determine if there is a match of payee names.

2. A method according to claim 1, further comprising:
presenting the check to a human operator for manual review if the determination is made that there is a mismatch of payee names.

3. A method according to claim 1, wherein the check data file comprises a positive pay file.

4. A payment method comprising the steps of:
(a) receiving from a bank customer a check data file which contains details of completed checks to be issued by the bank customer;
(b) receiving from a presenting bank one of the completed checks which has been issued by the bank customer;
(c) obtaining a check amount from the check data file received in step (a);
(d) capturing payee name data from the check received in step (b);
(e) based upon the check amount from step (c), selecting one of a plurality of recognition confidence thresholds; and
(f) based upon the selected recognition confidence threshold from step (e), comparing the captured payee name data of step (d) with payee name data contained in the check data file received in step (a) to determine if the check needs to be presented to a bank operator for manual review.

5. A payment method according to claim 4, wherein the check is presented to a bank operator for manual review when the comparison indicates that there is a mismatch of payee names.

6. A payment method according to claim 4, wherein the check data file comprises a positive pay file.

7. A method of processing a check in a payee positive pay system, the method comprising:
receiving a check from a presenting bank;
obtaining a check amount from the check received from the presenting bank;
recognizing a payee name from the check received from the presenting bank;
selecting a first recognition confidence threshold if the check amount is below a first predetermined amount;
selecting a second recognition confidence threshold which is different from the first recognition confidence threshold if the check amount is above a second predetermined amount; and
based upon the selected one of the first and second recognition confidence thresholds, comparing the recognized payee name with a payee name contained in a positive pay file which has been previously received from a payor of the check to determine if there is a match of payee names.

8. A method according to claim 7, further comprising:
presenting the check to a human operator for manual review if a comparison of payee names indicates a mismatch of payee names.

9. A method according to claim 7, wherein the first predetermined amount is less than the second predetermined amount.

10. A method according to claim 7, wherein the first predetermined amount and the second predetermined amount are the same.
